(19) United States
(12) Patent Application Publication
(10) Pub. No.: US 2016/0012974 A1
(43) Pub. Date: Jan. 14, 2016

(54) METHOD FOR MANUFACTURING SEMICONDUCTOR FILM, RAW-MATERIAL PARTICLES FOR SEMICONDUCTOR FILM MANUFACTURE, SEMICONDUCTOR FILM, PHOTOELECTRODE, AND DYE-SENSITIZED SOLAR CELL

(71) Applicant: SEKISUI CHEMICAL CO., LTD., Osaka-shi, Osaka (JP)

(72) Inventors: Tomoaki KATAGIRI, Tsukuba-shi (JP); Naohiro FUJINUMA, Tsukuba-shi (JP); Shunsuke KUNUGI, Tsukuba-shi (JP); Setsuo NAKAJIMA, Tsukuba-shi (JP)

(73) Assignee: SEKISUI CHEMICAL CO., LTD., Osaka (JP)

(21) Appl. No.: 14/772,174

(22) PCT Filed: Jul. 4, 2014
(86) PCT No.: PCT/JP2014/067869

§ 371 Date: Sep. 2, 2015

(30) Foreign Application Priority Data
Jul. 5, 2013 (JP) 2013-142016

(51) Int. Cl. H01G 9/20; H01G 9/00

(52) U.S. Cl. CPC H01G 9/2027; H01G 9/0029

(57) ABSTRACT

A method for producing a semiconductor film, comprising spraying raw material particles to a substrate to form a semiconductor film on the substrate, wherein the raw material particles comprise semiconductor particles each having adsorbed on its surface an aggregation-suppressive substance which suppresses aggregation of the semiconductor particles.

### TECHNICAL FIELD

The present invention relates to a method for producing a semiconductor film, raw material particles for producing a semiconductor film, a semiconductor film, a photoelectrode and a dye-sensitized solar cell.

Priority is claimed on Japanese Patent Application No. 2013-142016, filed Jul. 5, 2013, the contents of which are incorporated herein by reference.

### BACKGROUND ART

In recent years, as a method for producing a semiconductor film without requiring a sintering step, there is proposed a method in which semiconductor particles in the form of aerosol is sprayed onto a substrate (see, for example, Patent Document 1).

In this method, a substrate with a low heat resistance can be used since a sintering step performed in conventional techniques can be omitted. This method has further advantages such as shortened time required for the film formation. Therefore, the application of this method to the production of a photoelectrode of a dye-sensitized solar cell has been investigated (see, for example, Patent Document 2).

### PRIOR ART DOCUMENTS

### Patent Documents

Patent Document 1: Japanese Unexamined Patent Application Publication No. 2004-3928

Patent Document 2: WO2012/161161

### DISCLOSURE OF INVENTION

### Problems to be Solved by the Invention

It is difficult to stably form a semiconductor film by the method of forming a semiconductor film by spraying semiconductor particles (powder). Further, it has been found that a semiconductor film obtained by such a method suffers a defect. Specifically, when a photoelectrode is produced by causing a sensitizing dye to be adsorbed on the semiconductor film, the amount of adsorbed dye is relatively small so that only a low photoconversion efficiency can be achieved by a solar cell using the photoelectrode formed from the semiconductor film.

The present invention has been made in view of the above situation, and the object of the present invention is to provide a method for producing a semiconductor film with less fluctuation of the amount of raw material particles sprayed via a nozzle onto a substrate. Further objects of the present invention are to provide raw material particles for producing a semiconductor film to be produced by the aforementioned method, a semiconductor film produced by the method, a photoelectrode including the semiconductor film and a dye-sensitized solar cell including the photoelectrode.

### Means to Solve the Problems

The present inventors have made studies to identify the cause of the relatively small amount of dye adsorbed on the semiconductor film. As a result, they have found that the semiconductor films with relatively small amount of adsorbed dye are non-uniform in respect of film thickness and porosity, and presumed that this non-uniformity is caused by the fluctuation of the amount of raw material particles sprayed onto the film. Further, the present inventors have made extensive and intensive studies to identify the cause of the fluctuation of the sprayed amount. As a result, it was considered that the aggregation of the particles before being formulated into aerosol for spraying proceeds due to electrostatic attraction or other factors while being unnoticed by production workers, thereby forming aggregates of various sizes (secondary particle diameters) in the aerosol. This leads to a presumption that the breakage of the aggregated inorganic particles at the collision thereof against a substrate causes unintended formation of voids which render the resulting film relatively sparse (meaning that the porosity of the film is too high), so that the amount of adsorbed dye becomes relatively small. Based on this presumption, the present inventors have made extensive and intensive studies toward developing a method for preventing aggregation of the particles due to electrostatic attraction and the like before the particles are formulated into aerosol, and have completed the present invention. Specifically, the present invention provides the following measures.

[1] A method for producing a semiconductor film, including spraying raw material particles to a substrate to form a semiconductor film on the substrate, wherein the raw material particles include semiconductor particles each having adsorbed on its surface an aggregation-suppressive substance which suppresses aggregation of the semiconductor particles.
[2] The method according to [1], wherein the aggregation-suppressive substance is a substance having a composition different from that of the semiconductor particles.
[3] The method according to [1] or [2], wherein the aggregation-suppressive substance is an organic molecule.
[4] The method according to [3], wherein the organic molecule has a hetero atom.
[5] The method according to [3] or [4], wherein the organic molecule has a hydroxyl group, a nitrile group, a carboxy group, a silyl group, a thiol group, a carbonyl group or an ether bond.
[6] The method according to any one of [1] to [5], wherein the semiconductor particles in the raw material particles have an average particle diameter of 10 nm to 100 μm.
[7] The method according to any one of [1] to [6], wherein the raw material particles further include semiconductor particles having no aggregation-suppressive substance adsorbed on surfaces thereof, and an amount of the semiconductor particles each having adsorbed on its surface the aggregation-suppressive substance is 20% by weight or more, based on the total weight of the raw material particles.
[8] The method according to any one of [1] to [7], wherein the raw material particles include large diameter semiconductor particles and small diameter semiconductor particles, said large diameter semiconductor particles having an average particle diameter which is at least 1.2 times that of said small diameter semiconductor particles, and

wherein the amount of said large diameter semiconductor particles is 5 to 90% by weight, based on the total weight of the raw material particles.

[9] The method according to [8], wherein the average particle diameter of said large diameter semiconductor particles is 50 nm to 3 μm.
[10] The method according to any one of [1] to [9], wherein the semiconductor particles are particles formed of an inorganic oxide semiconductor.
[11] The method according to any one of [3] to [10], including:

a raw material particle-formation step including dispersing the semiconductor particles in the organic molecule, and drying the resultant by evaporation of the organic molecule, thereby obtaining the raw material particles including semiconductor particles each having adsorbed on its surface the organic molecule, and

a film-formation step including spraying the raw material particles to the substrate to form a semiconductor film on the substrate.

[12] The method according to any one of [3] to [11], wherein the organic molecule has a normal boiling point of 30 to 160° C.
[13] The method according to any one of [1] to [12], wherein the semiconductor film is a porous film
[14] A semiconductor film produced by the method according to any one of [1] to [13].
[15] A photoelectrode including the semiconductor film of [14] and a sensitizing dye adsorbed on the semiconductor film.
[16] A dye-sensitized solar cell including the photoelectrode of [15].
[17] Raw material particles for producing a semiconductor film, including semiconductor particles each having adsorbed on its surface an aggregation-suppressive substance which suppresses aggregation of the semiconductor particles.
[18] The raw material particles according to [17], wherein the aggregation-suppressive substance is a substance having a composition different from that of the semiconductor particles.
[19] The raw material particles according to [17], wherein the aggregation-suppressive substance is an organic molecule.
[20] The raw material particles according to [17] to [19], wherein the organic molecule has a hetero atom.
[21] The raw material particles according to [19] or [20], wherein the organic compound has a hydroxyl group, a nitrile group, a carboxy group, a silyl group, a thiol group, a carbonyl group or an ether bond.
[22] The raw material particles according to [17] to [21], wherein the semiconductor particles in the raw material particles have an average particle diameter of 10 nm to 100 μm.
[23] The raw material particles according to any one of [17] to [22], wherein the semiconductor particles are particles formed of an inorganic oxide semiconductor.
[24] The raw material particles according to any one of [19] to [23], wherein the organic molecule has a normal boiling point of 30 to 160° C.
[25] The raw material particle according to any one of [17] to [24], wherein the semiconductor film is a porous film.

### Effect of the Invention

By the method of the present invention, a semiconductor film can be produced while suppressing the fluctuation of the sprayed amount of the raw material particles, thereby enabling to stably control the thickness and porosity of the semiconductor film to be formed. As a result, the amount of dye adsorbed on the resulting semiconductor film can be increased to relatively high level, thereby enabling the production of a photoelectrode and a dye-sensitized solar cell photoelectrode with excellent photoconversion efficiency.

### BRIEF DESCRIPTION OF THE DRAWINGS

FIG. 1 is a schematic view of a film-forming apparatus which can be used for carrying out the method of the present invention for producing a semiconductor film

FIG. 2 is a SEM image of a semiconductor film produced in Example 1 according to the present invention.

FIG. 3 is a SEM image of a semiconductor film produced in Comparative Example 1.

### DETAILED DESCRIPTION OF THE INVENTION

Hereinbelow, the present invention is described based on the preferred embodiments thereof with reference to the drawings which, however, should not be construed as limiting the scope of the present invention.

### <<Method for Producing a Semiconductor Film>>

The method for producing a semiconductor film according to the first aspect of the present invention includes spraying raw material particles to a substrate to form a semiconductor film on the substrate, wherein the raw material particles include semiconductor particles each having adsorbed on its surface an aggregation-suppressive substance which suppresses aggregation of the semiconductor particles.

The type of the semiconductor particles is not particularly limited, and examples thereof include semiconductor particles (inorganic semiconductor particles) made of known inorganic substances such as known inorganic oxide semiconductor particles used in a photoelectrode of a dye-sensitized solar cell. More specific examples include titanium oxide and zinc oxide. With respect to the titanium oxide, the crystal structure thereof may be any of anatase, rutile and brookite. In the case of a porous film composed of anatase-type titanium oxide, such a film exhibits a reaction activity higher than a porous film composed of rutile-type titanium oxide and, hence, enables more efficient electron injection from the sensitizing dye. On the other hand, the rutile-type titanium oxide has high refractive index; therefore, a porous film composed of rutile-type titanium oxide is useful for further improving the light scattering effect and light utilization efficiency of the porous film. With respect to the aforementioned semiconductor particles, a single type thereof may be used independently or two or more types thereof may be used in combination.

The size (average particle diameter) of the semiconductor particles is not particularly limited, and is preferred to be approximately in the range of 10 nm to 100 μm for forming a porous film constituting a photoelectrode of a dye-sensitized solar cell. Further, the size (average particle diameter) of the raw material particles including semiconductor particles each having adsorbed on its surface an aggregation-suppressive substance is also preferred to be approximately in the range of 10 nm to 100 μm

The aforementioned raw material particles may include large diameter semiconductor particles and small diameter semiconductor particles. With respect to the large diameter semiconductor particles, it is preferred that that the large diameter semiconductor particles are not aggregates of smaller particles. The prevention of aggregation of particles and evaluation of aggregation can be performed by any conventional method at any point in time before the raw material particles are used in the production of a semiconductor film (e.g., prior to the treatment with the aggregation-suppressive substance). The prevention of aggregation of particles can be effected by ultrasonic irradiation or the like. The evaluation of aggregation of particles can be carried out, for example, by using a nano particle size analyzer “SALD-7500nano” manufactured by Shimadzu Corporation.

The average particle diameter of the large diameter semiconductor particles is preferred to be approximately in the range of 50 nm to 3 μm. When the average particle diameter of the large diameter semiconductor particles is 50 nm or more, the sunlight can more easily enter into the inside of the porous film in an instance where the semiconductor film is used as a porous film for a solar cell. When the average particle diameter of the large diameter semiconductor particles is 3 μm or less, it becomes easy to prevent intrusion of too large an amount of smaller particles into the gaps between the large diameter particles, which renders difficult the entry of sunlight into the inside of the porous film. The average particle diameter of the large diameter semiconductor particles is more preferably 100 nm to 2 μm, and still more preferably 150 nm to 1.5 μm.

The average particle diameter of the large diameter semiconductor particles is larger than that of the small diameter semiconductor particles preferably by 1.2 times or more, more preferably 1.2 to 30 times, and still more preferably 2.0 to 20 times. When the average particle diameter of the large diameter semiconductor particles is larger by 1.2 times or more, it becomes possible to enable the sunlight to enter into the inside of the porous film more easily in an instance where the semiconductor film is used as a porous film for a solar cell, while causing an appropriate amount of small diameter particles to be present between the large diameter particles. As a result, it becomes possible to achieve higher power generation efficiency as compared to the case where only large diameter particles are used. When the average particle diameter of the large diameter semiconductor particles is larger by 30 times or less, it becomes easy to prevent intrusion of too large an amount of smaller particles into the gaps between the large diameter particles in an instance where the semiconductor film is used as a porous film for a solar cell, which renders difficult the entry of sunlight into the inside of the porous film. As a result, it becomes possible to suppress the lowering of power generation efficiency.

The amount of the aforementioned large diameter semiconductor particles is preferably 5 to 90% by weight, based on the total amount of the raw material particles. When the amount of the large diameter semiconductor particles is 5% by weight or more, the sunlight can more easily enter into the inside of the porous film in an instance where the semiconductor film is used as a porous film for a solar cell. When the amount of the large diameter semiconductor particles is 90% by weight or less, it becomes possible to cause an appropriate amount of small diameter particles to be present between the large diameter particles, to thereby improve the power generation efficiency of the solar cell. The amount of the large diameter semiconductor particles is more preferably 25 to 75% by weight, and still more preferably 35 to 65% by weight.

As examples of method for determining the average particle diameters of the semiconductor particles and the raw material particles, there can be mentioned a method in which the average particle diameter is determined as a peak value in the volume average particle diameter distribution obtained by a measurement performed by a laser diffraction particle size analyzer or a small angle X-ray scattering analyzer, or a method in which the major axes (diameters) of a plurality of particles are measured by observation via a transmission electron microscope or a scanning electron microscope (SEM), and an average value of the measured values is obtained. With respect to the number of particles to be measured for obtaining the average value, it is more preferable that the number is larger. For example, the average particle diameter can be obtained as an average value of the major axes of 30 to 100 inorganic particles. It is preferred that the average diameters of the primary particles and aggregates of the semiconductor particles can be measured by the aforementioned observation via a scanning electron microscope (SEM).

The aforementioned aggregation-suppressive substance is a substance capable of suppressing aggregation of the semiconductor particles, and is preferably a substance capable of suppressing aggregation of the semiconductor particles caused by electrostatic attraction.

By the adsorption of the aggregation-suppressive substance on the surfaces of the semiconductor particles, the aggregation of the semiconductor particles can be suppressed by, for example, preventing physical and direct contact between the semiconductor particles (in the form of a powder) at the surfaces thereof.

With respect to the aggregation-suppressive substance, it is preferred that at least a part of the surface of each semiconductor particle is coated with the aggregation-suppressive substance, and it is more preferred that the whole of the surface of each semiconductor particle is coated with the aggregation-suppressive substance.

The amount of the aggregation-suppressive substance adsorbed on the surface of each semiconductor particle is preferably such that the aggregation-suppressive substance is coated on the surface to form a thin layer having a thickness corresponding to a (total) length of 1 to 10 molecules of the aggregation-suppressive substance, for example, a thickness of several angstroms to several nanometers. Such a thin layer of the coated aggregation-suppressive substance need not have such a thickness that the layer can be visually observed, for example, a thickness of several micrometers. When the layer of the coated aggregation-suppressive substance is too thick, the adhesion of the raw material particles to the substrate for forming the semiconductor film may become undesirably weak due to the adhesion between the raw material particles per se sprayed onto the substrate.

The adhesion of the aggregation-suppressive substance on the surfaces of the semiconductor particles can be confirmed by various known analytical techniques. For example, when the coated semiconductor particles are analyzed by infrared spectroscopy (IR method), from the presence of a signal ascribed to the aggregation-suppressive substance in the obtained IR spectra, the conclusion can be drawn that the aggregation-suppressive substance is adsorbed on the surfaces of the analyzed particles.

The aggregation-suppressive substance is preferably a substance having a composition different from that of the semiconductor particles, and is more preferably an organic substance or an organic molecule. Here, the “organic substance” means a substance including a carbon atom. Similarly, the “organic molecule” means a molecule having at least one carbon atom. The total number of carbon atoms and hydrogen atoms constituting the organic molecule is preferably 50% or more, based on the total number of atoms constituting the organic molecule.

With respect to the aforementioned aggregation-suppressive substance, a single type thereof may be used independently or two or more types thereof may be used in combination.

Further, it is also a preferred embodiment of the present invention to use raw material particles including semiconductor particles having no aggregation-suppressive substance adsorbed on the surfaces thereof (hereinafter, also referred to as “untreated semiconductor particles”) as well as the semiconductor particles having the aggregation-suppressive substance adsorbed on the surfaces thereof (hereinafter, also referred to as “surface-treated semiconductor particles”).

Specifically, in this embodiment, the amount of the surface-treated semiconductor particles is preferably 20% by weight or more, based on the total weight of the semiconductor particles included in the raw material particles. When the amount is 20% by weight or more, it is possible to obtain a satisfactory effect of suppressing the aggregation of the raw material particles. The amount of the surface-treated semiconductor particles is more preferably 25% by weight or more, and still more preferably 30% by weight or more.

Further, the amount of the surface-treated semiconductor particles is preferably 97% by weight or less, based on the total weight of the semiconductor particles included in the raw material particles. When the amount is 97% by weigh or less, it becomes possible to prevent the lowering of the conversion efficiency of the semiconductor film formed from the raw material particles during the photovoltaic power generation. The amount of the surface-treated semiconductor particles is more preferably 95% by weight or less, more preferably 90% by weight or less.

That is, in the present invention, the amount of the surface-treated semiconductor particles is preferably 20 to 97% by weight, more preferably 25 to 95% by weight, and still more preferably 30 to 90% by weight.

The molecular weight of the aforementioned organic molecule is not particularly limited; however, for appropriately coating the surfaces of the semiconductor particles, the molecular weight is preferably 30 to 10,000, more preferably 30 to 1,000, and still more preferably 30 to 300. In the case of an organic molecule having a molecular weight of more than 10,000, e.g., when the organic molecule is a polymer, undesirably thick coating of the organic molecule may be formed on the surfaces of the semiconductor particles.

The organic compound preferably has a hetero atom. Specifically, it is preferred that the organic molecule is an organic molecule having a polar group containing a heteroatom. Here, the “heteroatom” means any atom other than carbon atom and hydrogen atom. Examples of heteroatoms include an oxygen atom, a sulfur atom, a nitrogen atom, and a halogen atom.

As the aforementioned organic molecule having a hetero atom, it is preferred to use an organic molecule having a heteroatom-containing substituent (polar group) such as a hydroxyl group (—OH), a nitrile group (—CN), a carboxyl group (—COOH), a silyl group (—SiH₃), a thiol group (—SH), a carbonyl group (—C(═O)—) or an ether linkage (—O—) (ether group). Examples of halogens include fluorine, chlorine, bromine and iodine.

As the basic structure of the organic molecule, there can be mentioned hydrocarbons, such as an aliphatic hydrocarbon and an aromatic hydrocarbon. Here, the “aliphatic hydrocarbon” means a hydrocarbon having no aromaticity. The aliphatic hydrocarbon may be saturated or unsaturated. More specific examples of aliphatic hydrocarbons include a linear or branched aliphatic hydrocarbon, and an aliphatic hydrocarbon having a ring in its structure. The organic molecule has preferably 1 to 30 carbon atoms, more preferably 1 to 20 carbon atoms, and still more preferably 1 to 10 carbon atoms. It is preferred that at least one of the hydrogen atoms of the aforementioned hydrocarbon is substituted with the heteroatom or the heteroatom-containing substituent.

In the skeleton of the organic molecule, the heteroatom or heteroatom-containing substituent may substitute at least one hydrogen atom of the aliphatic or aromatic hydrocarbon, or may substitute at least one “—CH₂—” moiety of the aliphatic hydrocarbon or at least one “—CH═” moiety of the aromatic hydrocarbon. However, a direct bond between two or more oxygen atoms is excluded.

The aforementioned silyl group may have at least one hydrogen bond thereof substituted with a monovalent hydrocarbon group. Examples of the hydrocarbon group include aliphatic hydrocarbon groups. Here, the “aliphatic hydrocarbon group” means a hydrocarbon group having no aromaticity. The aliphatic hydrocarbon group may be saturated or unsaturated. More specific examples of aliphatic hydrocarbons include a linear or branched aliphatic hydrocarbon. The hydrocarbon group has preferably 1 to 12 carbon atoms, more preferably 1 to 9 carbon atoms, and still more preferably 1 to 6 carbon atoms. Further, at least one methylene group (—CH₂—) constituting the hydrocarbon group may be replaced by an oxygen atom (—O—). However, when two or more methylene groups are replaced by oxygen atoms, the two or more methylene groups are not neighboring ones. The hydrocarbon group is preferably a linear or branched alkyl group.

Specific examples of the organic molecule having a heteroatom include alcohols such as methanol, ethanol, 1-propanol, 2-propanol and n-butanol; aliphatic ketones such as acetone and methyl ethyl ketone; nitriles such as acetonitrile and benzonitrile; alkoxysilanes such as isobutyl trimethoxysilane, n-decyltrimethoxysilane, diisobutyldimethoxysilane, n-octyltriethoxysilane, n-hexyl trimethoxy silane and n-hexyltriethoxysilane; aliphatic ethers such as tetrahydrofuran and diethyl ether; and amides such as N, N-dimethylformamide and N-methylpyrrolidone; sulfoxides such as dimethyl sulfoxide; nitrogen-containing aromatic compounds such as pyridine and quinoline; alkyl halides such as chloroform and 1,2-dichloroethane. Among the above-exemplified organic molecules each having a heteroatom, especially preferred are ethanol, acetone, acetonitrile and hexyltriethoxysilane.

With respect to the aforementioned organic molecule having a heteroatom, a single type thereof may be used independently or two or more types thereof may be used in combination. However, when two or more types of organic molecules are used, for efficiently achieving a sufficient aggregation prevention effect, it is preferred to choose such a combination of the organic molecules that there is no intermolecular force between the organic molecules and the organic molecules are not reactive with each other. Accordingly, from this point of view, it is preferred to use a single type of the organic molecule.

With respect to the method for producing a semiconductor film according to this embodiment, it is preferred that the method includes a raw material particle-formation step and a film-formation step, which are explained below. Further, the method of the present invention may include any other steps as well as the aforementioned two steps as long as such other steps do not deviate from the gist of the present invention.

### <Raw Material Particle-Formation Step>

The raw material particle-formation step is a step including dispersing the semiconductor particles in the organic molecule, and drying the resultant by evaporation of the organic molecule, thereby obtaining the raw material particles including semiconductor particles each having adsorbed on its surface the organic molecule as the aggregation-suppressive substance (such raw material particles are hereinafter also referred to as “surface-treated semiconductor particles”). Further, as mentioned above, the raw material particles may be a mixture of the surface-treated semiconductor particles and untreated semiconductor particles.

It is preferred that the organic molecule is in a liquid state under standard conditions where the temperature is 25° C. and the pressure is 1 atm (approximately 105 Pa). By adding the semiconductor particles into the liquid of the organic molecule and sufficiently stirring the resulting liquid, it is possible to obtain a dispersion where the semiconductor particles are dispersed while being separated from each other.

The boiling point of the organic molecule under 1 atm (approximately 105 Pa) is preferably 30 to 160° C., more preferably 30 to 140° C., still more preferably 30 to 120° C. When the boiling point of the organic molecule is within the aforementioned range, the organic molecule can be relatively easily evaporated from the dispersion.

The method for evaporating the organic molecule from the dispersion is not particularly limited. For example, the volatilization of the organic molecule may be promoted by placing the dispersion under a reduced pressure. Further, if necessary, the dispersion may be heated.

The method for drying the semiconductor particles after evaporation of the organic molecule from the dispersion is also not particularly limited. However, the drying at a high temperature (e.g., at 300° C.) may cause disadvantages such as decomposition or loss of the organic molecule remaining adhered to the surfaces of the semiconductor particles even after the evaporation. For preventing such disadvantages, it is preferred to allow the semiconductor particles to dry naturally by leaving the semiconductor particles to stand or mildly stirring the particles under a relatively mild temperature condition (such as room temperature) after removal of most of the organic molecule by evaporation. By thus drying the semiconductor particles under such a mild condition, it becomes possible to easily obtain a powder comprised of the raw material particles including semiconductor particles having the organic molecule adhered to the surfaces thereof. The completion of the drying can be judged, for example, by visual observation to evaluate whether or not the powder is loose and fluid without appearing to be wet, and the drying is judged to be complete, for example, when the semiconductor particles are dried to a level such that the particles are applicable to the process for preparation of an aerosol of the raw material particles as described below. Further, before the use of the obtained raw material particles, it is preferred to confirm that the organic molecule is adhered to the surfaces of the semiconductor particles by an analytical method such as a qualitative determination of functional groups of the organic molecule by an IR method or an evaluation of the thermal gravity change by TG measurement (thermogravimetry).

Further, as a method for indirectly confirming the adhesion of the organic molecule to the surfaces of the semiconductor particles, there can be mentioned methods such as a SEM observation and an average particle diameter measurement.

The aggregation of the semiconductor particles can be evaluated by a SEM observation of the semiconductor particles before and after the treatment with the organic molecule.

More specifically, for example, the prevention of aggregation of the particles can be confirmed by the reduction of the average particle diameter after the treatment with the organic molecule or the emergence of a sharp peak in the particle diameter distribution which results from the reduction of the average particle diameter after the treatment with the organic molecule.

### <Film-Formation Step>

The film-formation step is a step including spraying the raw material particles to the substrate to form a semiconductor film on the substrate.

As a method for spraying the raw material particles to the substrate, there can be mentioned an aerosol deposition method (AD method) in which an aerosol obtained by mixing a carrier gas with the raw material particles is sprayed onto a substrate, an electrostatic particle coating method in which the raw material particles are accelerated by electrostatic attraction, and a cold spray method. Of these spraying methods, preferred is the AD method which enables easy formation of a porous film suitable for a photoelectrode. With respect to the details of the AD method which can be employed in the present invention, reference can be made to, for example, WO2012/161161. Hereinbelow, specific explanations are made on the application of the AD method.

### <Film Formation by AD Method>

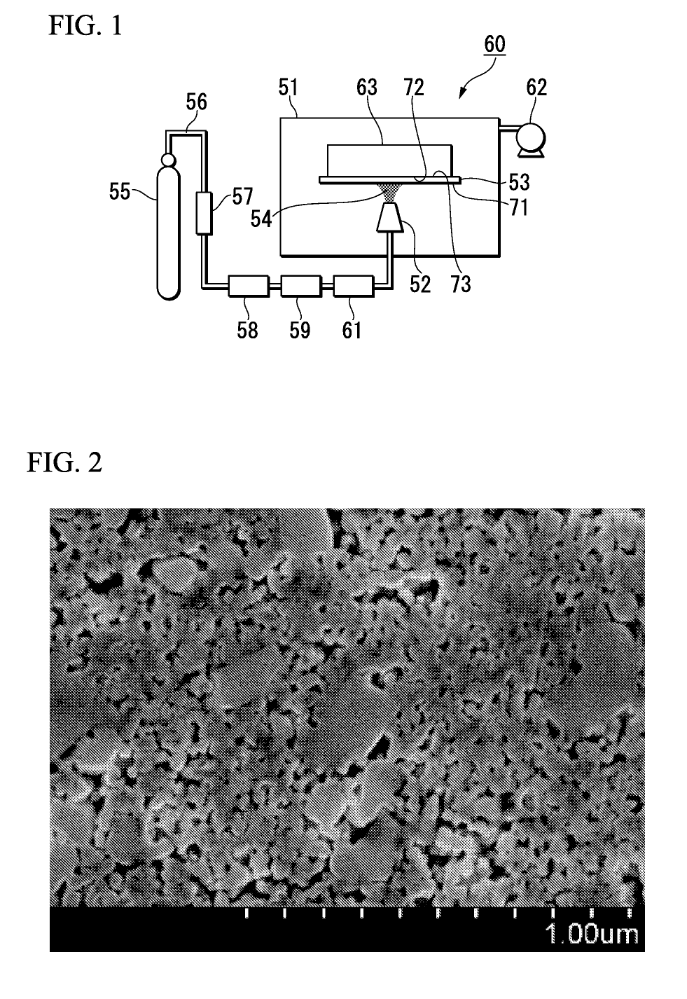

Hereinbelow, one embodiment of the present invention is explained with reference to FIG. 1. The drawing referred to in the following explanations is for illustrative purpose only, and does not necessarily represent the actual dimensions such as ratios of length, width and thickness, which can be changed appropriately.

FIG. 1 shows a construction of a film-forming apparatus 60 which can be used in the present embodiment. However, the film-forming apparatus usable in the present invention is not limited to one having a construction as shown in FIG. 1 as long as the apparatus can be used for spraying the raw material particles to the substrate.

### <Film-Forming Apparatus>

The film-forming apparatus 60 has a gas cylinder 55, a transport tube 56, a base 63 and a film-forming chamber 51. The gas cylinder 55 is filled with gas (hereinafter, referred to as “transport gas”) for spraying the raw material particles 54 to the substrate 53 while accelerating the raw material particles 54. The gas cylinder 55 is connected with one end of the transport tube 56. The transport gas is supplied from the gas cylinder 55 to the transport tube 56.

The transport tube 56 is provided with a mass flow controller 57, an aerosol generator 58, a crushing device 59 for appropriately adjusting the dispersion of the raw material particles 54 in the transport gas, and a classifier 61 in this order from the upstream side. By the crushing device 59, the adhesion of the raw material particles due to moisture and the like can be broken. Further, even if some raw material particles have passed through the crushing device 59 while remaining adhered to each other, such particles can be removed by the classifier 61.

By the mass flow controller 57, the flow rate of the transport gas supplied from the gas cylinder 55 to the transport tube 56 can be adjusted. The aerosol generator 58 is filled with the raw material particles 54. The raw material particles 54 are dispersed in the transport gas supplied from the mass flow controller 57, and are transferred to the crushing device 59 and the classifier 61.

The nozzle 52 is positioned so that the opening (not shown) of the nozzle 52 faces the substrate 53 on the base 63. The nozzle 52 is connected with the other end of the transport tube 56. The transport gas containing the raw material particles 54 is sprayed onto the substrate 53 through the opening of the nozzle 52.

On the upper surface 72 of the base 63, the substrate 53 is placed so that one surface 73 of the substrate 53 contacts the upper surface 72 of the base 63. The other surface 71 (film-formation surface) of the substrate faces the opening of the nozzle 52. The raw material particles 54 sprayed from the nozzle 52 together with the transport gas collides with the film-formation surface on which a porous film composed of the raw material particles 54 is formed.

The base 63 of the film-formation apparatus 60 is preferably a part formed of such a material that enables an appropriate control of the energy of collision between the raw material particles 54 and the substrate 53 on the film-formation surface 71 and the energy of collision between the raw material particles 54 in accordance with the average particle diameter, hardness and spray rate of the raw material particles 54. When the base 63 is such a part, the adhesion of the raw material particles 54 to the film-formation surface 71 can be enhanced, and the raw material particles 54 deposited on the surface 71 can be easily bonded to each other, so that a porous film having a high porosity can be easily formed.

The substrate 53 is preferably made of such a material that the raw material particles 54 sprayed can be bonded to the film-formation surface 71 without penetrating through the surface 71. From this point of view, the substrate 53 may be a glass substrate, a resin substrate, a resin film, a resin sheet, a metal substrate or the like. With respect to the substrates exemplified above, a non-conductive substrate preferably has a transparent conductive film formed on the surface thereof in advance. The transparent conductive film may be made of ITO (tin-doped indium oxide) or the like. The porous film formed on the substrate by the AD method disclosed in the aforementioned WO publication and the like has such structural strength and conductivity as required of a photoelectrode and, hence, need not be further subjected to a calcination treatment. For this reason, the substrate used in the present invention may be made of resins having low heat resistance. The thickness of the substrate is not particularly limited, but it is preferred that the substrate has a thickness such that the raw material particles sprayed do not penetrate through the substrate. Specific choice of the substrate 53 can be appropriately made in view of film forming conditions such as the type of the raw material particles 54 and the spraying rate, and use of the formed film.

The film-forming chamber is provided for forming a film under a reduced pressure. A vacuum pump 62 is connected to the film-forming chamber 51 so that the pressure within the film-forming chamber 51 can be reduced appropriately. Further, the film-forming chamber 51 is provided with a means (not shown) for exchanging the base.

### <Method for Spraying>

Hereinbelow, explanations are made with respect to one example of the method for spraying the raw material particles 54.

First, the vacuum pump 62 is operated to reduce the pressure within the film-forming chamber 51. The pressure within the film-forming chamber is not particularly limited, but is preferably set to be 5 to 1,000 Pa. This level of reduced pressure suppresses the convection within the film-forming chamber 51 so that the raw material particles 54 can be easily sprayed to a desired portion of the film-formation surface 71.

Next, the transport gas is supplied from the gas cylinder 55 to the transport tube 56, where the flow rate and amount of the transport gas is controlled by the mass flow controller 57. Examples of the transport gas include commonly employed gases such as O₂, N₂, Ar, He and air.

The flow rate and amount of the transport gas can be appropriately controlled in view of the type, average particle diameter, flow rate and amount of the raw material particles 54 sprayed from the nozzle 52.

The raw material particles 54 are charged into the aerosol generator 58 where the raw material particles 54 are dispersed in the transport gas flowing through the transport tube 56 and accelerated. From the opening of the nozzle 52, the raw material particles 54 are ejected at a velocity of subsonic to supersonic range to thereby deposit the particles 54 on the film-formation surface 71 of the substrate 53. The spraying rate of the raw material particles 54 to the film-formation surface 71 can be, for example, set within the range of from 10 to 1,000 m/sec. However, the spraying rate is not limited to the above range, but can be appropriately controlled in view of the material of the substrate 53, the type and size of the raw material particles 54, and the like.

By appropriately adjusting the flow rate and amount of the transport gas, the structure of the semiconductor film formed of the raw material particles 54 can be controlled to be either dense or porous. Similarly, the porosity of the porous film can be appropriately controlled. The general tendency is that the higher the spraying rate of the raw material particles 54, the structure of the resulting film is more likely to be dense (lower in porosity). Further, when the film formation is performed at an extremely low spraying rate, a semiconductor film having a sufficiently high strength may not be obtained where the obtained film may be in the form of a pressurized powder body. For obtaining a porous film having sufficiently high structural strength, it is preferred to employ a spraying rate which is approximately intermediate between the spraying rate for obtaining a dense film and the spraying rate for obtaining a pressurized powder body.

By continuing the spraying of the raw material particles 54, the sprayed raw material particles 54 successively collide into the particles 54 bonded to the film-formation surface 71 of the substrate 53, and the collision between the particles 54 generates new surfaces on the particles 54 at which the particles 54 are bonded together. Here, the aggregation-suppressive substance is removed by the collision between the particles and, hence, does almost not hinder the generation of new surfaces and the subsequent bonding between the particles. Further, the collision between the raw material particles 54 does not cause a temperature rise such that the whole of the raw material particle 54 melts, so that almost no vitreous boundary layer is formed on the new surface.

When the thickness of the porous film formed of the raw material particles 54 reaches a predetermined value (e.g., 1 μm to 100 μm), the spraying of the raw material particles 54 is stopped.

By the procedure as explained above, a porous film composed of the raw material particles 54 having a desired thickness can be formed on the film-formation surface 71 of the substrate 53.

### <<Semiconductor Film>>

The semiconductor film according to the second aspect of the present invention is a film formed on a substrate by the method according to the first aspect of the present invention. The semiconductor film may have either a dense structure or a porous structure. According to the method of the first aspect of the present invention, the raw material particles can be sprayed at a stable rate, so that it becomes possible to easily form a porous film which is uniform in structural strength and has such a high porosity as would increase the adsorption of dye. When the semiconductor film of the present invention in the form of such a porous film is applied to a photoelectrode of a dye-sensitized solar cell, the cell can exhibit excellent photoconversion efficiency. The dye-adsorption density (unit:10⁸ mol/cm² μm¹) of the semiconductor film of the present invention is preferably 0.8 to 2.0, more preferably 0.8 to 1.9, and especially preferably 0.8 to 1.8.

The use of the semiconductor film of the second aspect of the present invention is not limited to a photoelectrode, but the semiconductor film can be used in a wide variety of fields where the physical or chemical properties of the semiconductor film can be utilized.

### <<Photoelectrode>>

The photoelectrode according to the third aspect of the present invention is a photoelectrode including the semiconductor film according to the second aspect on which a sensitizing dye is adsorbed. The sensitizing dye is not particularly limited, and any known sensitizing dye can be used. That is, by adding a step for causing a sensitizing dye to be adsorbed on the semiconductor film to the method according to the first aspect, the photoelectrode according to the third aspect can be produced. In the third aspect of the present invention, it is preferred that the semiconductor film is formed on a transparent conductive electrode substrate.

Examples of the dye include ruthenium-based dyes such as cis-di(thiocyanato)-bis(2,2′-bipyridyl-4,4′-dicarboxylic acid)ruthenium (II), a bis-tetrabutylammonium salt of cis-di(thiocyanato)-bis (2,2′-bipyridyl-4,4′-bis-dicarboxylic acid)ruthenium (II) (hereinafter, abbreviated as N719), and a tris-tetrabutyl ammonium salt of tri(thiocyanato)-(4,4′,4″-tricarboxy-2,2′:6′,2″-terpyridine)ruthenium (black dye). Further, it is also possible to use various organic dyes, such as a coumarin dye, a polyene dye, a cyanine dye, a hemicyanine dyes, a thiophene dye, an indoline-based dye, a xanthene dye, a carbazole dye, a perylene dye, a porphyrin dye, a phthalocyanine dye, a merocyanine dye, a catechol dye, and a squarylium dye. Still further examples of the dye include donor-acceptor type dyes including combinations of the above-mentioned dyes. As the dye adhered to the oxide semiconductor layer 3, one type of dye or a combination of two or more types of dyes may be used. When two or more types of dyes are used, the combination and the ratio of the dyes may be appropriately selected to suit the purpose.

As a method for causing the sensitizing dye to be adsorbed on the semiconductor film, there can be mentioned a method in which the formed semiconductor film is immersed in a solution of the sensitizing dye.

The dye-adsorption density (unit:10⁻⁸ mol/cm² μm¹) of the semiconductor film is preferably 0.8 to 2.0, more preferably 0.8 to 1.9, and especially preferably 0.8 to 1.8.

The photoelectrode according to the third aspect can be produced by any conventional methods except for the use of the semiconductor film according to the second aspect. For example, the photoelectrode according to the third aspect can be produced by a method in which a sensitizing dye is caused to be adsorbed on the semiconductor film formed on the substrate, and, if necessary, a lead-out wire is connected to the transparent conductive film in the vicinity of the semiconductor film.

### <<Dye-Sensitized Solar Cell>>

The dye-sensitized solar cell according to the fourth aspect of the present invention has the photoelectrode according to the third aspect, a counterelectrode, and an electrolytic solution or an electrolyte layer. When an electrolytic solution is used, It is preferred that the photoelectrode and the counterelectrode are sealed together by a sealing member to contain the electrolytic solution therebetween.

As the substrate on which the semiconductor film is formed to provide the photoelectrode, it is possible to use a resin film or a resin sheet on which a transparent conductive film is formed. As the resin (plastic), it is preferred to use a resin capable of transmitting visible light, examples of which include an acrylic polymer, a polycarbonate, a polyester, a polyimide, a polystyrene, a polyvinyl chloride, and a polyamide.

Of these, polyesters, especially a polyethylene telephthalate (PET), are produced in large scale and widely used as transparent heat-resistant films. By the use of such a resin substrate, it becomes possible to produce a thin and light-weighed dye-sensitized solar cell.

As the aforementioned electrolytic solution, for example, any of those generally used in known dye-sensitized solar cells can be used. In the electrolytic solution, an electrolyte is dissolved. The electrolytic solution may include any other additives such as a filler and a thickener as long as the use of such additives does not deviate from the gist of the present invention.

In the present invention, an electrolytic layer may be provided instead of using the electrolytic solution. The electrolytic layer has the same function as the electrolytic solution and may be in the form of either gel or solid. The electrolytic layer may be, for example, a layer formed by a method in which a gelling agent or a thickener is added to an electrolytic solution, followed by, if necessary, removal of the solvent, to thereby convert the electrolytic solution into a gel or a solid. The use of the electrolytic layer in the form of gel or solid can eliminate the danger of leakage of an electrolytic solution from the dye-sensitized solar cell.

As the aforementioned sealing member, for example, any of sealing resins generally used in known dye-sensitized solar cells can be used. Examples of the sealing resins include ultraviolet curable resins, thermosetting resins, and thermoplastic resins. The thickness of the sealing member is not particularly limited, but is preferred to be appropriately adjusted such that the photoelectrode and the counterelectrode are separated with a predetermined distance therebetween, and the electrolytic solution or the electrolytic layer has a predetermined thickness.

The dye-sensitized solar cell according to the fourth aspect can be produced by any conventional methods except for the use of the photoelectrode according to the third aspect. For example, the dye-sensitized solar cell according to the fourth aspect can be produced by a method in which the electrolytic liquid or the electrolyte is placed between the photoelectrode and the counterelectrode, followed by sealing, and, if necessary, a lead-out wire is connected to the photoelectrode and/or the counterelectrode.

### <<Raw Material Particles for Producing Semiconductor Film>>

The raw material particles (for producing the semiconductor film) according to the fifth aspect of the present invention are particles used for producing the semiconductor film by the method according to the first aspect. The type and amount of the raw materials for producing the raw material particles and the method for producing the raw material particles are as described above in connection with the method (for producing a semiconductor film) according to the first aspect.

### EXAMPLES

Hereinbelow, the present invention will be described in more detail with reference to the Examples which, however, should not be construed as limiting the present invention.

### Example 1

As a substrate, an ITO-PEN substrate was used, which is a PEN (polyethylenenaphthalate) substrate having formed thereon a film of ITO (tin-doped indium oxide).

### <Preparation of Raw Material Particles>

As the semiconductor particles, a powder mixture was used, which was a mixture of TiO₂ particles having an average particle diameter of 20 nm (P25 manufactured by NIPPON AEROSIL CO., LTD.) and TiO₂ particles having an average particle diameter of 200 nm (ST-41 manufactured by ISHIHARA SANGYO KAISHA, LTD.) where the weight ratio of these two types of TiO₂ particles was 50:50.

The average particle diameters of the TiO₂ particles were measured by laser diffraction particle size analyzer SALD-7000 (manufactured by Shimadzu Corporation) with respect to a 30% by mass dispersion of TiO₂ particles in ethanol.

The powder mixture was dispersed in ethanol to give a concentration of 30% by weight, followed by sufficient stirring. The resulting was dried under a reduced pressure to remove liquid ethanol, to thereby obtain raw material particles composed of the semiconductor particles having ethanol molecules adhered on the surfaces thereof (i.e., semiconductor particles coated with ethanol).

The adsorption of ethanol on the surfaces of the semiconductor particles in the raw material particles was confirmed by the IR analysis of the surfaces of the particles. More specifically, peaks were observed at 2974 cm⁻¹ and 1455 cm⁻¹ in the obtained IR spectrum, which were considered to be ascribed to ethanol, whereby the presence of ethanol on the surfaces of the particles was confirmed.

### <Film Formation>

The powder mixture was formed into a film using a film-forming apparatus 60 shown in FIG. 1.

Specifically, the raw material particles were sprayed via a nozzle having a 10 mm×0.5 mm rectangular opening onto an ITO-PEN substrate in a film-forming chamber 51. In this procedure, N2 gas as a transport gas was supplied from a gas cylinder 55 to a transport tube 56, where the flow rate of the transport gas was adjusted by a mass flow controller 57. The raw material particles to be sprayed were charged into an aerosol generator 58, where the particles were dispersed in the transport gas and transported to a crushing device 59 and a classifier 61, and the raw material particles were sprayed onto a substrate 53 via a nozzle 52. A vacuum pump 62 was connected to the film-forming chamber 51, whereby negative pressure was created and maintained within the film-forming chamber 51. The transport rate at the nozzle 52 was set to be 5 mm/sec.

By spraying the raw material particles onto the substrate, a porous film composed of semiconductor particles which have ethanol molecules adhered on the surfaces thereof and are bonded together could be obtained.

### Example 2

The same mixture of semiconductor particles (powder mixture) as used in Example 1 was dispersed in acetone to give a concentration of 30% by weight, followed by sufficient stirring and subsequent drying under a reduced pressure, to thereby remove liquid acetone. As a result, raw material particles composed of the semiconductor particles having acetone molecules adhered on the surfaces thereof (i.e., semiconductor particles coated with acetone) were obtained. The adsorption of acetone on the surfaces of the semiconductor particles in the raw material particles was confirmed by the IR analysis of the surfaces of the particles.

Using the thus obtained raw material particles, a porous film was produced in the same manner as in Example 1. As a result, a porous film composed of semiconductor particles which have acetone molecules adhered on the surfaces thereof and are bonded together could be obtained.

### Example 3

The same mixture of semiconductor particles (powder mixture) as used in Example 1 was dispersed in acetonitrile to give a concentration of 30% by weight, followed by sufficient stirring and subsequent drying under a reduced pressure, to thereby remove liquid acetonitrile. As a result, raw material particles composed of the semiconductor particles having acetonitrile molecules adhered on the surfaces thereof (i.e., semiconductor particles coated with acetonitrile) were obtained. The adsorption of acetonitrile on the surfaces of the semiconductor particles in the raw material particles was confirmed by the IR analysis of the surfaces of the particles.

Using the thus obtained raw material particles, a porous film was produced in the same manner as in Example 1. As a result, a porous film composed of semiconductor particles which have acetonitrile molecules adhered on the surfaces thereof and are bonded together could be obtained.

### Example 4

The same mixture of semiconductor particles (powder mixture) as used in Example 1 was dispersed in ethanol to give a concentration of 30% by weight. To the resulting dispersion was added 1% by weight hexyltriethoxysilane, followed by sufficient stirring and subsequent drying under a reduced pressure. Thus, liquid ethanol was removed, to thereby obtain raw material particles composed of the semiconductor particles having ethanol molecules adhered on the surfaces thereof (i.e., semiconductor particles coated with ethanol) and having hydroxyl groups on the surfaces thereof chemically bonded to hexyltriethoxysilane. The adhesion of ethanol and chemical bond of hexyltriethoxysilane to the surfaces of the semiconductor particles in the raw material particles were confirmed by the IR analysis of the surfaces of the particles.

Using the thus obtained raw material particles, a porous film was produced in the same manner as in Example 1. As a result, a porous film composed of semiconductor particles which have on the surfaces thereof adhered ethanol molecules and chemically bonded hexyltriethoxysilane and are bonded together could be obtained.

### Example 5

The same mixture of semiconductor particles (powder mixture) as used in Example 1 was dispersed in ethanol to give a concentration of 30% by weight, followed by sufficient stirring and subsequent drying under a reduced pressure, to thereby remove liquid ethanol. As a result, semiconductor particles having ethanol molecules adhered on the surfaces thereof (i.e., semiconductor particles coated with ethanol) were obtained. The thus obtained semiconductor particles are hereinafter referred to as “surface-treated semiconductor particles”. The adsorption of ethanol on the surfaces of the semiconductor particles in the surface-treated semiconductor particles was confirmed by the IR analysis of the surfaces of the particles.

The surface-treated semiconductor particles and the same untreated mixture of semiconductor particles (powder mixture) as used in Example 1 were mixed with a weight ratio of 50:50, to thereby obtain raw material particles. Using the thus obtained raw material particles, a porous film was produced in the same manner as in Example 1. As a result, a porous film including semiconductor particles which have ethanol molecules adhered on the surfaces thereof could be obtained.

### Example 6

The same mixture of semiconductor particles (powder mixture) as used in Example 1 was dispersed in ethanol to give a concentration of 30% by weight, followed by sufficient stirring and subsequent drying under a reduced pressure, to thereby remove liquid ethanol. As a result, semiconductor particles having ethanol molecules adhered on the surfaces thereof (i.e., semiconductor particles coated with ethanol) were obtained. The thus obtained semiconductor particles are hereinafter referred to as “surface-treated semiconductor particles”. The adsorption of ethanol on the surfaces of the semiconductor particles in the surface-treated semiconductor particles was confirmed by the IR analysis of the surfaces of the particles.

The surface-treated semiconductor particles and the same untreated mixture of semiconductor particles (powder mixture) as used in Example 1 were mixed with a weight ratio of 97:3, to thereby obtain raw material particles. Using the thus obtained raw material particles, a porous film was produced in the same manner as in Example 1. As a result, a porous film including semiconductor particles which have ethanol molecules adhered on the surfaces thereof could be obtained.

### Example 7

The same mixture of semiconductor particles (powder mixture) as used in Example 1 was dispersed in ethanol to give a concentration of 30% by weight, followed by sufficient stirring and subsequent drying under a reduced pressure, to thereby remove liquid ethanol. As a result, semiconductor particles having ethanol molecules adhered on the surfaces thereof (i.e., semiconductor particles coated with ethanol) were obtained. The thus obtained semiconductor particles are hereinafter referred to as “surface-treated semiconductor particles”. The adsorption of ethanol on the surfaces of the semiconductor particles in the surface-treated semiconductor particles was confirmed by the IR analysis of the surfaces of the particles.

The surface-treated semiconductor particles and the same untreated mixture of semiconductor particles (powder mixture) as used in Example 1 were mixed with a weight ratio of 30:70, to thereby obtain raw material particles. Using the thus obtained raw material particles, a porous film was produced in the same manner as in Example 1. As a result, a porous film including semiconductor particles which have ethanol molecules adhered on the surfaces thereof could be obtained.

### Example 8

The same mixture of semiconductor particles (powder mixture) as used in Example 1 was dispersed in ethanol to give a concentration of 30% by weight, followed by sufficient stirring and subsequent drying under a reduced pressure, to thereby remove liquid ethanol. As a result, semiconductor particles having ethanol molecules adhered on the surfaces thereof (i.e., semiconductor particles coated with ethanol) were obtained. The thus obtained semiconductor particles are hereinafter referred to as “surface-treated semiconductor particles”. The adsorption of ethanol on the surfaces of the semiconductor particles in the surface-treated semiconductor particles was confirmed by the IR analysis of the surfaces of the particles.

The surface-treated semiconductor particles and the same untreated mixture of semiconductor particles (powder mixture) as used in Example 1 were mixed with a weight ratio of 99:1, to thereby obtain raw material particles. Using the thus obtained raw material particles, a porous film was produced in the same manner as in Example 1. As a result, a porous film including semiconductor particles which have ethanol molecules adhered on the surfaces thereof could be obtained.

### Comparative Example 1

As the semiconductor particles, a powder mixture was used, which was a mixture of TiO₂ particles having an average particle diameter of 20 nm (P25 manufactured by NIPPON AEROSIL CO., LTD.) and TiO₂ particles having an average particle diameter of 200 nm (ST-41 manufactured by ISHIHARA SANGYO KAISHA, LTD.) where the weight ratio of these two types of TiO₂ particles was 50:50. The powder mixture was stirred sufficiently with a plastic spatula in the absence of a solvent, thereby obtaining raw material particles of Comparative Example 1. Using the thus obtained raw material particles of Comparative Example 1, a porous film was produced in the same manner as in Example 1.

### Comparative Example 2

As the semiconductor particles, a powder mixture was used, which was a mixture of TiO₂ particles having an average particle diameter of 20 nm (P25 manufactured by NIPPON AEROSIL CO., LTD.) and TiO₂ particles having an average particle diameter of 200 nm (ST-41 manufactured by ISHIHARA SANGYO KAISHA, LTD.) where the weight ratio of these two types of TiO₂ particles was 50:50. The powder mixture was dispersed in H₂O to give a concentration of 30% by weight, followed by sufficient stirring and subsequent drying under a reduced pressure. In the resulting dried product, the particles were aggregated. The aggregated particles were broken to obtain raw material particles of Comparative Example 2. Using the thus obtained raw material particles of Comparative Example 2, a porous film was produced in the same manner as in Example 1.

### <<Evaluation 1 of Film-Formation>>

With respect to the film-formation process carried out in each of Examples 1 to 8 and Comparative Examples 1 and 2, the fluctuation of sprayed amount of the particles was evaluated by measuring the weight reduction of the raw material particles per unit time (per one minute) which occurs during the supply of the raw material particles for spraying from a supply bottle provided in the aerosol generator 58 to the nozzle 52. The results are shown in Table 1.

TABLE 1

| | Sprayed amount of particles (g/min) | | | | | |
|---|---|---|---|---|---|---|
| | 0-1 | 1-2 | 2-3 | 3-4 | 4-5 | 5-6 |
| | min. | min. | min. | min. | min. | min. |
| Example 1 | 0.31 | 0.28 | 0.30 | 0.29 | 0.30 | 0.28 |
| Example 2 | 0.28 | 0.31 | 0.29 | 0.29 | 0.31 | 0.28 |
| Example 3 | 0.30 | 0.32 | 0.31 | 0.29 | 0.30 | 0.31 |
| Example 4 | 0.31 | 0.30 | 0.31 | 0.31 | 0.30 | 0.30 |
| Example 5 | 0.30 | 0.30 | 0.31 | 0.31 | 0.30 | 0.31 |
| Example 6 | 0.31 | 0.30 | 0.29 | 0.31 | 0.32 | 0.30 |
| Example 7 | 0.28 | 0.31 | 0.29 | 0.29 | 0.31 | 0.28 |
| Example 8 | 0.28 | 0.30 | 0.29 | 0.30 | 0.28 | 0.31 |
| Comparative | 0.10 | 0.38 | 0.12 | 0.19 | 0.09 | 0.24 |
| Example 1 | | | | | | |
| Comparative | 0.12 | 0.08 | 0.38 | 0.07 | 0.20 | 0.20 |
| Example 2 | | | | | | |

From the results shown in Table 1, it is apparent that the sprayed amount of the raw material particles in each of Examples 1 to 8 was almost constant over time, thereby indicating that a desired amount of raw material particles can be stably sprayed onto a substrate. The result is considered to indicate that the particles in the raw material particles were not aggregated together and remained to be independent from each other at the time of spraying.

On the other hand, in each of Comparative Examples 1 and 2, a large fluctuation was observed with respect to the sprayed amount of the raw material particles. The result is considered to indicate that, even if the aggregation of the raw material particles was not observed at such a macro level as can be visually observed, the aggregation of the particles had occurred in the raw material particles as observed at a more minute level, i.e., micro level.

### <<Evaluation 2 of Film-Formation>>

With respect to the film-formation process carried out in each of Examples 1 to 8 and Comparative Examples 1 and 2, the thickness of the formed film (porous film) was measured at respective points in time (shown in Table 1) during the spraying. When the substrate was changed to another substrate at some points in time during the film-formation, the spraying was temporarily terminated at each time for replacement of the substrate. The results are shown in Table 2.

TABLE 2

| | Points in time during spraying | | | | | |
|---|---|---|---|---|---|---|
| | 0-1 | 1-2 | 2-3 | 3-4 | 4-5 | 5-6 |
| | min. | min. | min. | min. | min. | min. |
| | Film thickness (μm) | | | | | |
| Sample | Film 1 | Film 2 | Film 3 | Film 4 | Film 5 | Film 6 |
| Example 1 | 5.2 | 5.3 | 5.1 | 5.4 | 5.3 | 5.1 |
| Example 2 | 5.5 | 5.5 | 5.7 | 5.0 | 5.2 | 5.0 |
| Example 3 | 4.9 | 5.2 | 5.5 | 5.4 | 5.1 | 5.2 |
| Example 4 | 5.1 | 5.0 | 4.9 | 5.0 | 5.1 | 4.9 |
| Example 5 | 4.9 | 5.1 | 5.0 | 4.9 | 5.0 | 5.1 |
| Example 6 | 5.2 | 5.1 | 5.4 | 5.5 | 5.2 | 4.9 |
| Example 7 | 5.0 | 5.2 | 5.0 | 5.7 | 5.5 | 5.5 |
| Example 8 | 5.1 | 5.3 | 5.4 | 5.1 | 5.3 | 5.2 |
| Comparative | 2.1 | 6.8 | 2.4 | 6.2 | 2.4 | 4.8 |
| Example 1 | | | | | | |
| Comparative | 3.8 | 4.5 | 7.0 | 3.2 | 5.5 | 4.2 |
| Example 2 | | | | | | |

From the results shown in Table 2, it is apparent that the thickness of the film formed in each of Examples 1 to 8 was almost constant over time, thereby indicating that a film having a desired thickness can be stably obtained. The reason for this result is presumed that the particles in the raw material particles were not aggregated together and remained to be independent from each other at the time of spraying.

On the other hand, in each of Comparative Examples 1 and 2, a large fluctuation was observed with respect to the thickness of the formed film. The reason for this result is presumed that, even if the aggregation of the raw material particles was not observed at such a macro level as can be visually observed, the aggregation of the particles had occurred in the raw material particles as observed at a more minute level, i.e., micro level.

### <<Evaluation of Formed Film>>

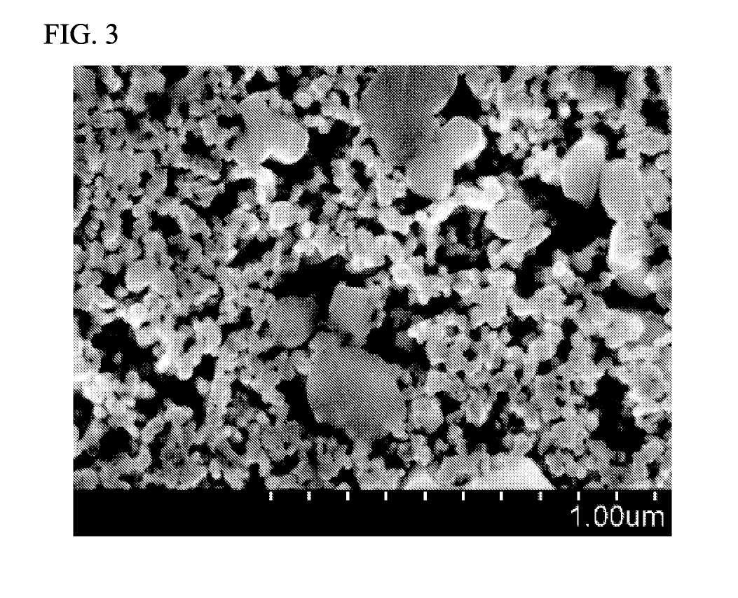

Each of the substrates having formed thereon the respective porous films of Examples 1 to 8 and Comparative Examples 1 and 2 was immersed in a 0.3 mM alcohol solution of ruthenium-complex dye (N719, manufactured by Solaronix Co., Ltd.) at room temperature for 18 hours, to thereby cause the dye to be adsorbed on the porous film. With respect to the obtained photoelectrode (photoelectrode substrate), the dye-adsorption density was determined by a method in which the photoelectrode was immersed in 0.1 M aqueous KOH solution to detach the dye from the photoelectrode, and the absorption spectrum of the dye dissolved in the KOH solution was measured. The results are shown in FIG. 3

Further, a SEM image was obtained with respect to the porous film of each of the photoelectrode substrates obtained in Example 1 and Comparative Example 1, based on which the film structure was observed. The results are shown in FIG. 2 (Example 1) and FIG. 3 (Comparative Example 1).

TABLE 3

| | Dye-adsorption density |
|---|---|
| | (10⁻⁸ mol/cm² μm¹) |
| Example 1 | 1.2 |
| Example 2 | 1.1 |
| Example 3 | 1.0 |
| Example 4 | 0.9 |
| Example 5 | 1.0 |
| Example 6 | 1.2 |
| Example 7 | 0.8 |
| Example 8 | 1.2 |
| Comparative | 0.7 |
| Example 1 | |
| Comparative | 0.6 |
| Example 2 | |

From the results shown in Table 3, FIGS. 2 and 3, it can be understood that the amount of the dye adsorption by the porous film is larger in Examples 1 to 8 than in Comparative Examples 1 and 2; hence, the porous films obtained in Examples 1 to 8 are superior as porous films for producing a photoelectrode substrate. From the SEM images of FIGS. 2 and 3, the reason for the larger amount of the dye adsorption in Examples 1 to 8 is considered that each of the porous films of Examples 1 to 8 has a more dense structure with a higher specific surface area.

### <<Evaluation of Performance of Dye-Sensitized Solar Cell>>

The photoelectrode substrate of each of Examples 1 to 8 and Comparative Examples 1 and 2 and a counterelectrode including a glass substrate with a platinum coating were oppositely positioned through a resin film having a thickness of 30 μm (Himilan manufactured by Du Pont-Mitsui Polychemicals Co., Ltd.) as a spacer disposed therebetween, and the resulting sandwich structure was press-bonded using a double clip. Further, an electrolytic solution (Iodolyte50, manufactured by Solaronix Co., Ltd.) was injected to a gap between the substrates through an inlet hole formed in advance in the counterelectrode substrate, followed by closing the inlet hole with a glass plate, to thereby produce a simple cell of a dye-sensitized solar cell. The effective light receiving area was 0.16 cm².

The performance such as photoconversion efficiency of each simple cell was evaluated by a solar simulator (AM1.5, 100 mW/cm²). The results are shown in Table 4.

TABLE 4

| | Isc | Voc | | Eff. | Film thickness |
|---|---|---|---|---|---|
| | (mA) | (V) | FF | (%) | (μm) |
| Example 1 | 1.5 | 0.75 | 0.74 | 5.2 | 6.2 |
| Example 2 | 1.4 | 0.74 | 0.74 | 4.8 | 6.1 |
| Example 3 | 1.6 | 0.73 | 0.73 | 5.3 | 6.4 |
| Example 4 | 1.4 | 0.72 | 0.75 | 4.7 | 6.1 |
| Example 5 | 1.4 | 0.74 | 0.75 | 4.8 | 6.1 |
| Example 6 | 1.5 | 0.75 | 0.75 | 5.3 | 6.3 |
| Example 7 | 1.4 | 0.75 | 0.74 | 4.8 | 6.2 |
| Example 8 | 1.3 | 0.74 | 0.75 | 4.5 | 6.2 |
| Comparative | 1.1 | 0.72 | 0.73 | 3.6 | 6.0 |
| Example 1 | | | | | |
| Comparative | 1.0 | 0.74 | 0.73 | 3.4 | 6.2 |
| Example 2 | | | | | |

From the results shown in Table 4, it is apparent that the photoconversion efficiency (Eff.) of the simple cell of each of Examples 1 to 8 is higher than the simple cell of each of Comparative Examples 1 and 2; hence, the cells of Examples 1 to 8 are superior as solar cells. The result is considered to reflect the difference in the amount of the dye-adsorption between the Examples and the Comparative Examples.

From the above, it is apparent that, by causing the aggregation-suppressive substance (such as organic molecules) to be adsorbed, in advance, on the surfaces of the semiconductor particles used in raw material particles for forming a porous film, it becomes possible to stabilize the sprayed amount of the raw material particles at the time of film-formation, which enables the production of a porous film suitable for use in a photoelectrode.

The elements, combinations thereof, etc. that are explained above in connection with the specific embodiments of the present invention are mere examples, and various alterations such as addition, omission and substitution of any components, etc. may be made as long as such alterations do not deviate from the gist of the present invention. The present invention should not be limited by the above explanations and is limited only by the annexed claims.

### INDUSTRIAL APPLICABILITY

The method for producing a semiconductor film, the raw material particles for producing a semiconductor film, the semiconductor film, the photoelectrode and the dye-sensitized solar cell according to the present invention are widely applicable in the field of solar cells.

### REFERENCE SIGNS LIST

51 Film-forming chamber 51
52 Nozzle
53 Substrate
54 Raw material particles
55 Gas cylinder
56 Transport tube
57 Mass flow controller
58 Aerosol generator
59 Crushing device
60 Film-forming apparatus
61 Classifier
62 Vacuum pump
63 Base
71 Film-formation surface
72 Substrate-placement surface (upper surface) of the base
73 Surface opposite to the film-formation surface

1. A method for producing a semiconductor film, comprising spraying raw material particles to a substrate to form a semiconductor film on the substrate, wherein the raw material particles comprise semiconductor particles each having adsorbed on its surface an aggregation-suppressive substance which suppresses aggregation of the semiconductor particles.

2. The method according to claim 1, wherein the aggregation-suppressive substance is a substance having a composition different from that of the semiconductor particles.

3. The method according to claim 1, wherein the aggregation-suppressive substance is an organic compound.

4. The method according to claim 3, wherein the organic compound has a hetero atom.

5. The method according to claim 3, wherein the organic compound has a hydroxyl group, a nitrile group, a carboxy group, a silyl group, a thiol group, a carbonyl group or an ether bond.

6. The method according to claim 1, wherein the semiconductor particles in the raw material particles have an average particle diameter of 10 nm to 100 μm.

7. The method according to claim 1, wherein the raw material particles further include semiconductor particles having no aggregation-suppressive substance adsorbed on surfaces thereof, and an amount of the semiconductor particles each having adsorbed on its surface the aggregation-suppressive substance is 20% by weight or more, based on the total weight of the raw material particles.

8. The method according to claim 1, wherein the raw material particles include large diameter semiconductor particles and small diameter semiconductor particles, said large diameter semiconductor particles having an average particle diameter which is at least 1.2 times that of said small diameter semiconductor particles, and
wherein the amount of said large diameter semiconductor particles is 5 to 90% by weight, based on the total weight of the raw material particles.

9. The method according to claim 8, wherein the average particle diameter of said large diameter semiconductor particles is 50 nm to 3 μm.

10. The method according to claim 1, wherein the semiconductor particles are particles formed of an inorganic oxide semiconductor.

11. The method according to claim 3, including:
a raw material particle-formation step including dispersing the semiconductor particles in the organic molecule, and drying the resultant by evaporation of the organic molecule, thereby obtaining the raw material particles including semiconductor particles each having adsorbed on its surface the organic molecule, and
a film-formation step including spraying the raw material particles to the substrate to form a semiconductor film on the substrate.

12. The method according to claim 3, wherein the organic molecule has a normal boiling point of 30 to 160° C.

13. The method according to claim 1, wherein the semiconductor film is a porous film.

14. A semiconductor film produced by the method according to claim 1.

15. A photoelectrode including the semiconductor film of claim 14 and a sensitizing dye adsorbed on the semiconductor film.

16. A dye-sensitized solar cell including the photoelectrode of claim 15.

17. Raw material particles for producing a semiconductor film including semiconductor particles each having adsorbed on its surface an aggregation-suppressive substance which suppresses aggregation of the semiconductor particles.

18. The raw material particles according to claim 17, wherein the aggregation-suppressive substance is a substance having a composition different from that of the semiconductor particles.

19. The raw material particles according to claim 17, wherein the aggregation-suppressive substance is an organic compound.

20. The raw material particles according to claim 17, wherein the organic compound has a hetero atom.

21. The raw material particles according to claim 19, wherein the organic compound has a hydroxyl group, a nitrile group, a carboxy group, a silyl group, a thiol group, a carbonyl group or an ether bond.

22. The raw material particles according to claim 17, wherein the semiconductor particles in the raw material particles have an average particle diameter of 10 nm to 100 μm.

23. The raw material particles according to claim 17, wherein the semiconductor particles are particles formed of an inorganic oxide semiconductor.

24. The raw material particles according to claim 19, wherein the organic molecule has a normal boiling point of 30 to 160° C.

25. The raw material particle according to claim 17, wherein the semiconductor film is a porous film.
